(19) United States
(12) Patent Application Publication
(10) Pub. No.: US 2015/0032420 A1
(43) Pub. Date: Jan. 29, 2015

(54) Systems and Methods for Creating Engineering Models

(71) Applicant: SAS IP, Inc., Cheyene, WY (US)

(72) Inventors: Joseph Tristano, McMurray, PA (US); Steven R. Elias, Waterloo (CA); Udo Tremel, Ottobrunn (DE); Glyn Jarvis, Surrey (GB); Vivek J. Joshi, Coraopolis (PA); Harsh Vardhan, Pune (IN); John Svitek, Pittsburgh, PA (US)

(73) Assignee: ANSYS, Inc., Canonsburg, PA (US)

(21) Appl. No.: 14/250,718

(22) Filed: Apr. 11, 2014

Related U.S. Application Data
(60) Provisional application No. 61/858,357, filed on Jul. 25, 2013.

(51) Int. Cl. G06F 17/50

(52) U.S. Cl. CPC G06F 17/50
USPC 703/1

(57) ABSTRACT

A processor-implemented system is provided for creating an engineering model for analyzing a physical object. One or more model operations are performed based at least in part on a computer-assisted-design (CAD) model. An engineering model is generated based at least in part on a mapping data structure that associates the CAD model with the engineering model.

### PRIORITY

This application claims the benefit under 35 U.S.C. §119(e) of the earlier filing date of U.S. Provisional Patent Application No. 61/858,357 filed on Jul. 25, 2013, the contents of which is hereby incorporated by reference.

### TECHNICAL FIELD

The present disclosure relates generally to the field of computational simulations, and, more specifically, to processor-implemented systems and methods for creating engineering models.

### BACKGROUND

Computer-aided-design (CAD) software allows a user to construct and manipulate complex three-dimensional models. A CAD model usually includes a collection of interconnected topological entities (e.g., vertices, edges, faces, bodies), geometric entities (e.g., points, trimmed curves, trimmed surfaces), and/or meshes. A mesh often includes a piecewise discretization of the CAD model.

### SUMMARY

As disclosed herein, processor-implemented systems and methods are provided for generating an engineering model to analyze a physical object. For example, model operations are performed to generate an engineering model based on a computer-assisted design (CAD) model.

As another example, a processor-implemented system is provided for creating an engineering model for analyzing a physical object. The system includes: a non-transitory computer-readable storage medium configured to store data related to a computer-assisted-design (CAD) model and one or more data processors. The data processors are configured to receive the CAD model including one or more original model elements, perform one or more model operations based at least in part on the CAD model, and generate, based at least in part on a mapping data structure, an engineering model including one or more target model elements, the mapping data structure associating the target model elements with the original model elements. The data processors are further configured to store, in the non-transitory computer-readable storage medium, the mapping data structure and data related to the engineering model for analyzing the physical object.

As yet another example, a processor-implemented system is provided for creating an engineering model for analyzing a physical object. The system includes: a non-transitory computer-readable storage medium configured to store data related to a computer-assisted-design (CAD) model and one or more data processors. The data processors are configured to: determine one or more simulation processes for the CAD model, wherein the simulation processes include a first task being sequentially connected to multiple second tasks, provide a visual representation of the one or more simulation processes on a user interface, and receive user operations on the first task and the second tasks from the user interface to modify the one or more simulation processes. The data processors are further configured to perform the one or more simulation processes to generate an engineering model based at least in part on a mapping data structure, the mapping data structure associating the engineering model with the CAD model, and store, in the non-transitory computer-readable storage medium, the mapping data structure, data related to the simulation processes, and data related to the engineering model for analyzing the physical object.

### BRIEF DESCRIPTION OF THE DRAWINGS

FIG. 1 depicts an example computer-implemented environment wherein users can interact with a model operation system hosted on one or more servers through a network.

FIG. 2 depicts an example diagram for generating an engineering topology.

FIG. 3 depicts an example diagram showing a visual representation of a simulation process including multiple model operations.

FIG. 4(A) depicts an example diagram showing creating of an engineering topology through model operations.

FIG. 4(B) depicts an example diagram showing a visual representation of the process for creating the engineering topology.

FIG. 5 depicts an example diagram showing a study object on a user interface.

FIG. 6 depicts an example diagram showing a task on a user interface.

FIG. 7 depicts an example diagram showing a simulation process including multiple tasks.

FIG. 8 depicts an example diagram showing a simulation process on a user interface.

FIG. 9 depicts an example diagram showing multiple simulation processes including multiple tasks.

FIG. 10 depicts another example diagram showing a simulation process including multiple tasks.

FIG. 11 depicts an example diagram showing various simulation milestones fulfilled by different tasks.

FIG. 12 depicts an example diagram showing a simulation settings object on a user interface.

FIG. 13 depicts an example diagram showing a simulation process using simulation settings.

FIG. 14 depicts an example diagram showing simulation settings associated with multiple simulation processes.

FIG. 15 depicts an example diagram showing an engineering data object on a user interface.

FIG. 16 depicts an example diagram showing simulation settings defined by engineering data.

FIG. 17 depicts an example diagram showing a group view of objects on a user interface.

FIG. 18 depicts an example diagram showing a system for performing model operations to generate an engineering model.

FIG. 19 depicts an example diagram showing a computing system for performing model operations to generate an engineering model.

### DETAILED DESCRIPTION

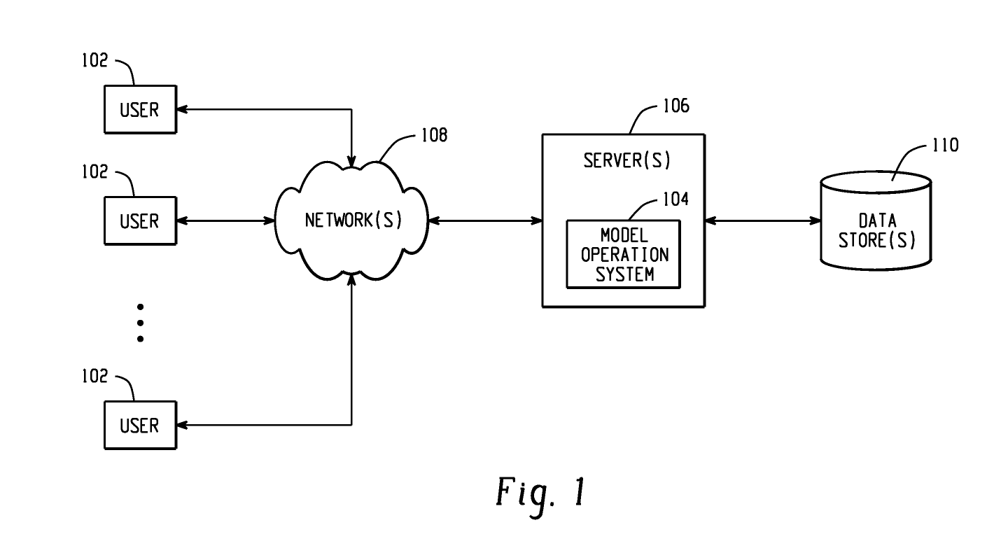

FIG. 1 depicts an example computer-implemented environment wherein users 102 can interact with a model operation system 104 hosted on one or more servers 106 through a network 108.

The model operation system 104 can assist the users 102 to generate an engineering model for analyzing a physical object based on a CAD model. Specifically, the model operation system 104 can create the engineering model for analyzing a physical object, such as beam and shell analysis, welding analysis, reduced dimension modeling, fracture mechanics analysis, etc. The model operation system 104 can add power and flexibility to the analysis of a physical object by providing user control over creation and exposure of the engineering model related to the physical object.

More specifically, the engineering model includes an engineering topology corresponding to a CAD topology in the CAD model. The engineering topology represents the engineering model suitable for engineering analysis and is associated with the CAD topology, e.g., through a mapping data structure. In addition, the model operation system 104 can implement one or more simulation processes that include multiple tasks connected sequentially for generating the engineering model. Further, the model operation system 104 can provide a visual representation of the simulation processes on a user interface and receive user operations on different tasks for modifying the simulation processes. The model operation system 104 performs one or more model operations on the CAD topology to generate the engineering topology. For example, the model operations correspond to certain tasks in the simulation processes.

As shown in FIG. 1, the users 102 can interact with the model operation system 104 through a number of ways, such as over one or more networks 108. One or more servers 106 accessible through the network(s) 108 can host the model operation system 104. The one or more servers 106 can also contain or have access to one or more data stores 110 for storing data for the model operation system 104.

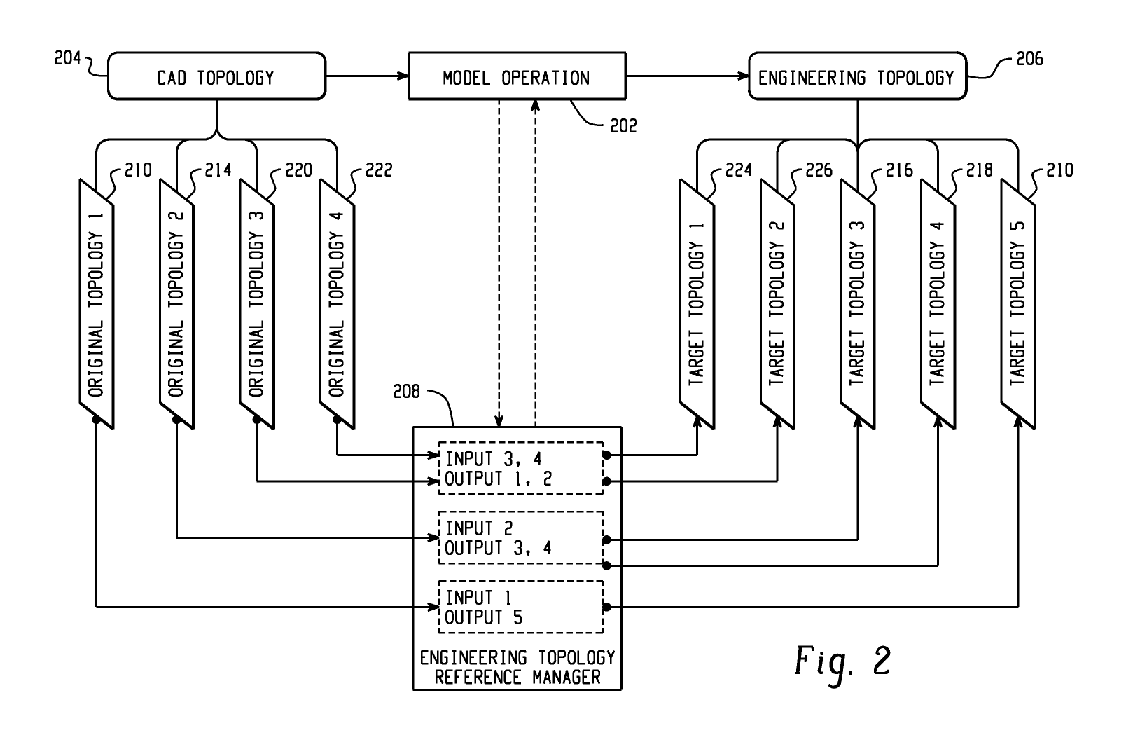

FIG. 2 depicts an example diagram for generating an engineering topology. As shown in FIG. 2, one or more model operations 202 are performed on a CAD topology 204 to generate an engineering topology 206, where the CAD topology 204 is associated with the engineering topology 206 through an engineering topology reference manager 208.

Specifically, the model operations 202 can be connected sequentially to form one or more simulation processes to generate the engineering topology 206. One or more pieces of heavyweight data (e.g., geometry data, mesh data, analysis data) related to original topological elements of the CAD topology 204 are used as input for the model operations 202 which generate or modify heavyweight data related to target topological elements of the engineering topology 206 as output. Additional properties (e.g., a resolution factor, etc.) that affect the model operations 202 can be used as additional inputs to the model operations 202. A property affects the state of a particular model operation in which the property is referenced, and the state of the particular model operation affects the data generated from the model operation. Any subsequent model operations (e.g., downstream model operations) can be updated based on the change of the generated data. Some of the additional properties are global properties, not specific to the CAD topology 204, and other additional properties are local properties associated with the CAD topology 204.

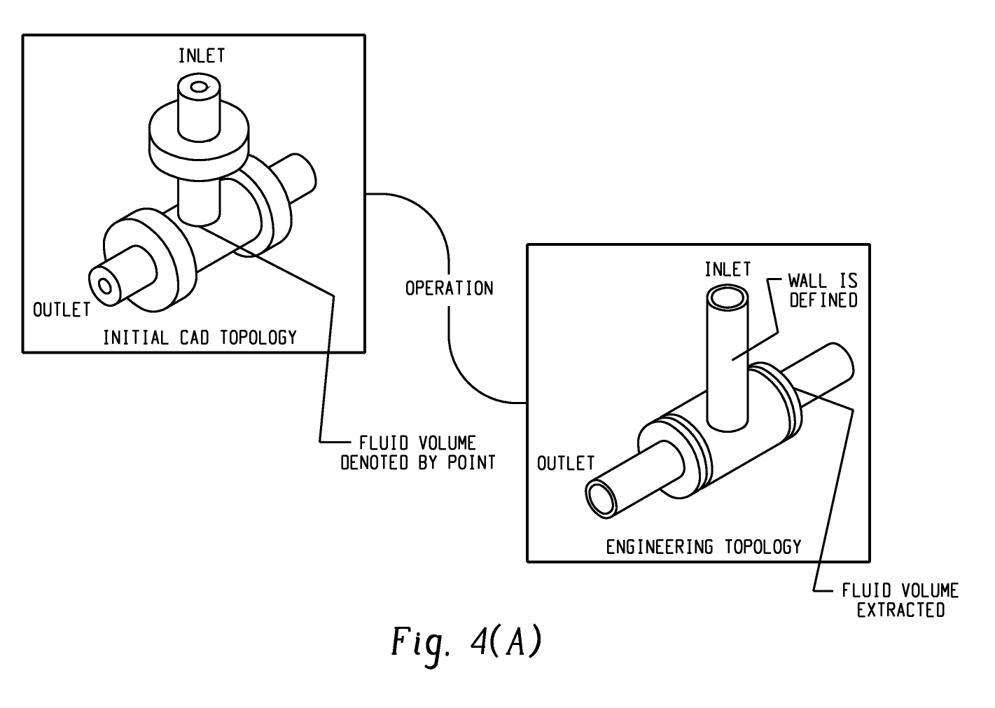

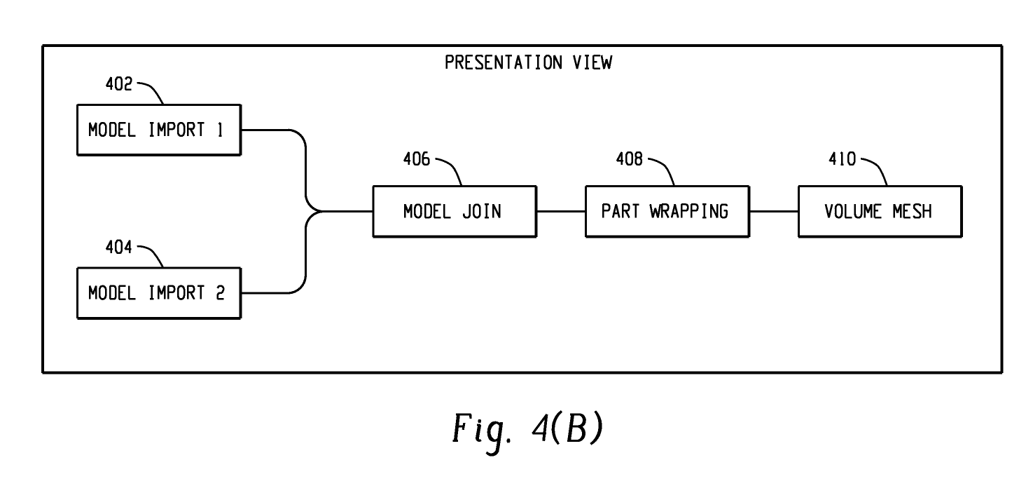

The engineering topology reference manager 208 is used to map the original topological elements of the CAD topology 204 to the target topological elements of the engineering topology 206. As shown in FIG. 2, the original topological element 210 is mapped to the target topological element 212, and the original topological element 214 is mapped to both the target topological element 216 and the target topological element 218. In addition, the original topological element 220 and the original topological element 222 are mapped to the target topological element 224 and the target topological element 226. As an example, the original topological element 210 corresponds to an inlet in a CAD topology as shown in FIG. 4(A), and the target topological element 212 corresponds to the inlet in an engineering topology as shown in FIG. 4(A).

The engineering topology reference manager 208 can update the mapping dynamically through the performance of the one or more model operations 202. In some embodiments, a template of model operations is created along with supporting data for generating the engineering topology 206 and exported and shared via emails and other electronic means, such as an electronic engineering knowledge management system or a product lifecycle management (PLM) system.

The model operations 202 include meshing for generating a mesh on a given topology, or geometry modeling for creating, modifying, and deleting geometric entities using a modeling kernel or virtual operations. In addition, the model operations 202 include wrapping for shrink-wrapping parts to create a new topology, or sewing (e.g., partitioning, cut-cell) for extracting a flow volume with a conformal solid topology from multiple parts. The model operations 202 also include mesh connections for connecting or welding shell models together at a mesh level, or fracture for inserting a crack into a mesh. Moreover, the model operations 202 include dimensional reduction for reducing a solid to a shell or reducing an assembly to mass/spring/dampers, resistors, etc. The model operations 202 further include configuration-management-and-combination for combining, transforming, scaling, and filtering a CAD model and a mesh from a single or multiple import operations or model generation operations. The model operations 202 additionally include importing, where a user imports a CAD model or a mesh. For example, a CAD import is a special case of configuration management.

The model operations 202 are applicable in different scenarios. For example, the model operations 202 are used for assembly meshing for conjugate heat transfer analysis. Solid and sheet CAD models and STereoLithography (STL) data are presented from mixed sources without a flow volume defined. The model operations 202 are performed to remove parts that are smaller than a desired size. In addition, the model operations 202 are performed to shrink-wrap parts that are overly complex and combine these parts with other parts with different materials that have impact on the flow but little effects on the heat transfer. The model operations 202 are performed to create a conformal topology to represent a combined flow volume and heat transfer regions, and mesh the result with a mixed Cartesian and structured mesh.

In a different scenario, the model operations 202 are used for selective meshing. A number of parts are presented to be decomposed and glued together for a hybrid structured, semi-structured, and free mesh. The model operations 202 are performed to decompose the geometry of the parts to be hex meshable. The model operations 202 are performed to mesh individual entities for a user and record the user's progress in these entities such that other users can work on parts with a common interface or the user can analyze alternative meshing strategies. The model operations 202 are performed to mesh a portion of the entities, such as transforming a solid into sheets or vice-versa.

The model operations 202 can be used for configuration management. Specifically, the model operations 202 can be used to configure or combine bits and pieces of CAD imports, mesh imports, or generated selective and assembly meshes to come to create an engineering model. In addition, the model operations 202 can be used for geometry editing. Particularly, the model operations 202 are performed to edit the geometry in a native environment with close ties to meshing, where a meshing component reacts to geometry changes as they occur. The real time meshing update is user controllable. Furthermore, the model operations 202 can be used for mesh connections and welding, where a selection of shell parts that are meshed or imported are connected with mesh connections or welds.

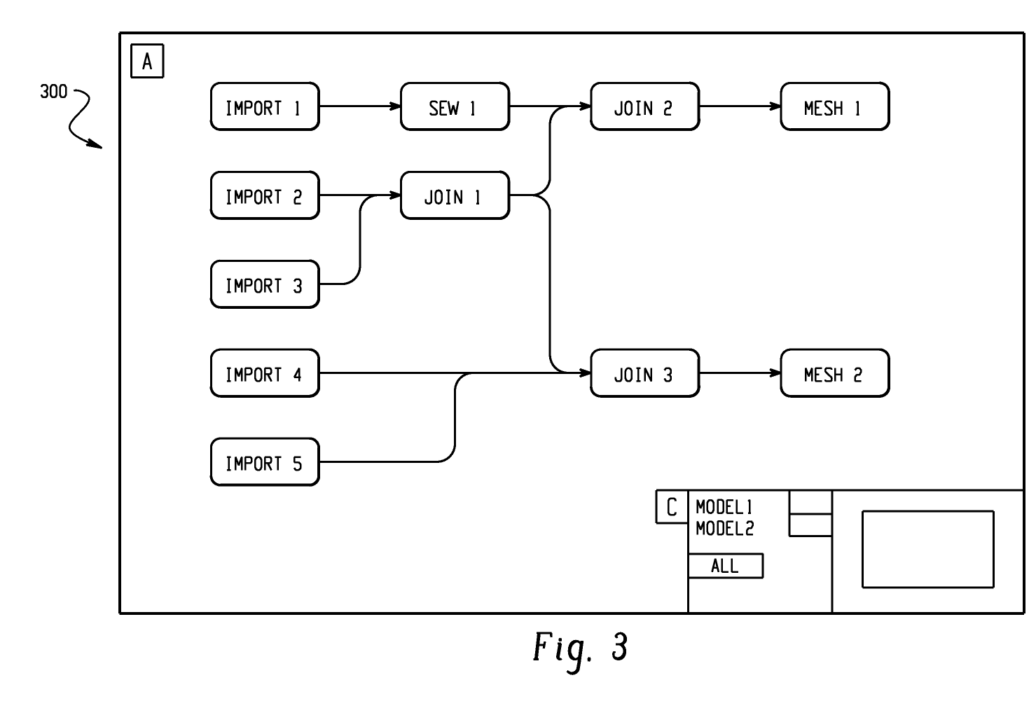

FIG. 3 depicts an example diagram showing a visual representation of a simulation process including multiple model operations. As shown in FIG. 3, model operations are connected in a sequential manner, where a model operation is connected to one or more other model operations. The visual presentation 300 provides a user with visual cues on state, connectivity and available downstream model operations and also allows the user to create a workflow template to distribute within the user's organization via electronic distribution or an electronic engineering management system. Version data and history can also be applied in the model operations to allow the user to see the metamorphosis of the user's process over time and allow the user to revert to an older version or choose bits and pieces from previous versions. The user can visually inspect and verify the engineering process and methods without having to know every detail of the process.

FIG. 4(A) depicts an example diagram showing creating of an engineering topology through model operations, and FIG. 4(B) depicts an example diagram showing a visual representation of the process for creating the engineering topology. As shown in FIG. 4(A) and FIG. 4(B), an engineering topology is generated based on an initial CAD topology through one or more model operations.

Specifically, the initial CAD topology includes pipe ends separated from a T-pipe, as shown in FIG. 4(A). As shown in FIG. 4(B), the pipe ends are imported using a model import operation 402, and the T-pipe is imported using another model import operation 404. A model join operation 406 is performed to combine the T-pipe and the pipe ends into a single model. In addition, one or more “Part Wrapping” operations 408 are performed to cap off holes in the pipe and a point is specified to represent an internal fluid. Boundary conditions are specified on the caps and physics on the point. For example, a user considers a wall includes every face that is bound by the point that is not the inlet or outlet. The “Part Wrapping” operations 408 are performed to create the engineering topology associated with the inlet and outlet capped faces along with creating a derived wall, as shown in FIG. 4(A). The user can evaluate physics data or properties based on the engineering topology and apply loads and boundary conditions directly to the engineering topology. In addition, a volume mesh operation 410 is performed on the engineering topology and moves on to a physics solution operation.

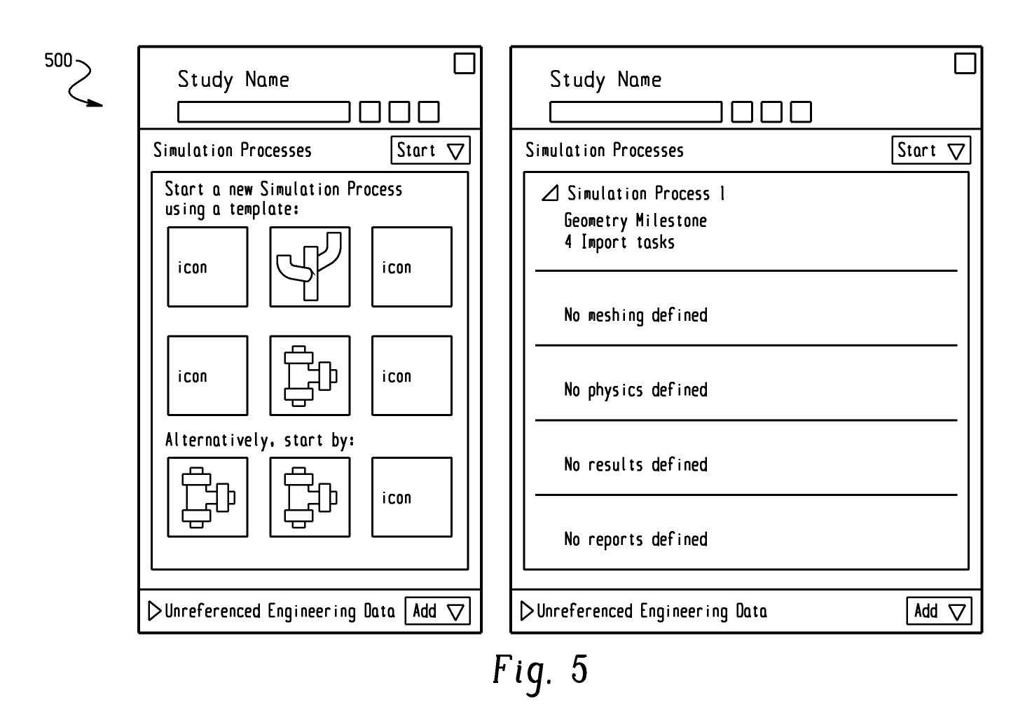

FIG. 5 depicts an example diagram showing a study object on a user interface. As shown in FIG. 5, the study object 500 includes a collection of simulation processes and related supporting data (e.g., engineering data). A simulation process is started using a template, and include a specific view of a collection of connected tasks with a single endpoint that enables an engineer to meet specific requirements of the simulation process. The supporting data (e.g., the engineering data) includes an object that is independent of usage across a study and can be reused.

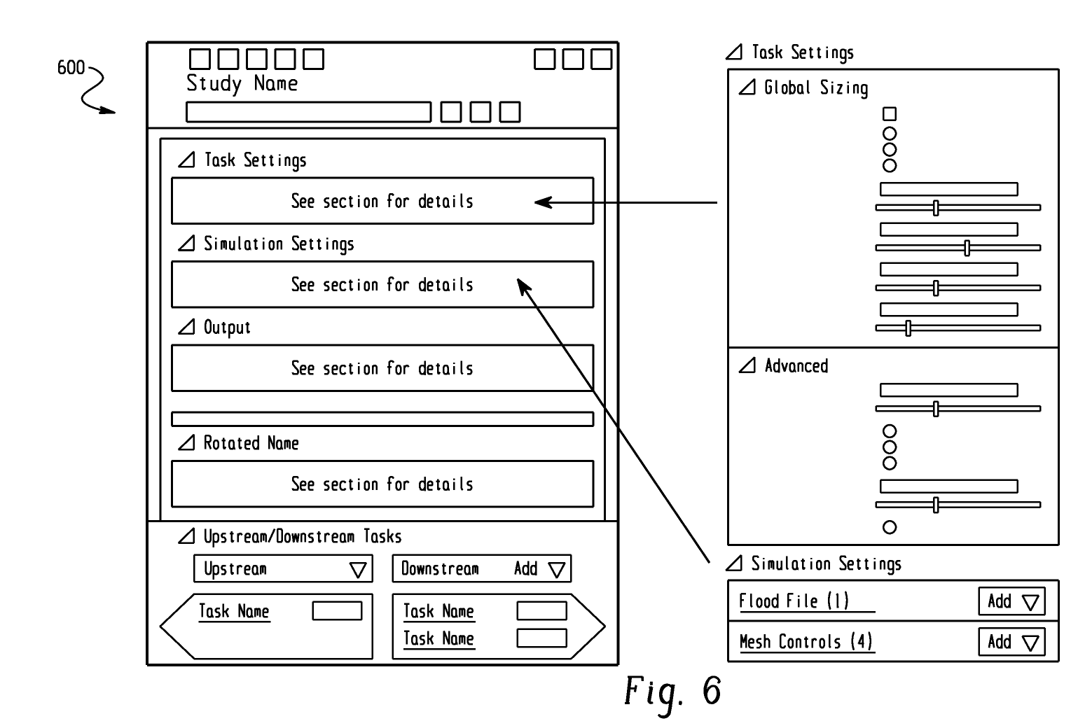

FIG. 6 depicts an example diagram showing a task on a user interface. The task 600 includes an object that uses output data from one or more upstream tasks, task settings and referenced objects of the task 600, and upon execution, generates data that can be consumed by one or more downstream tasks. A simulation setting includes an object that is added to the task 600 and used by the task 600 for producing output. In some embodiments, intermediary data is generated by the simulation setting. The simulation setting is also associated with multiple tasks (e.g., being reused by the tasks). Engineering data is referenced by a simulation setting in a simulation process to affect the output of the task 600.

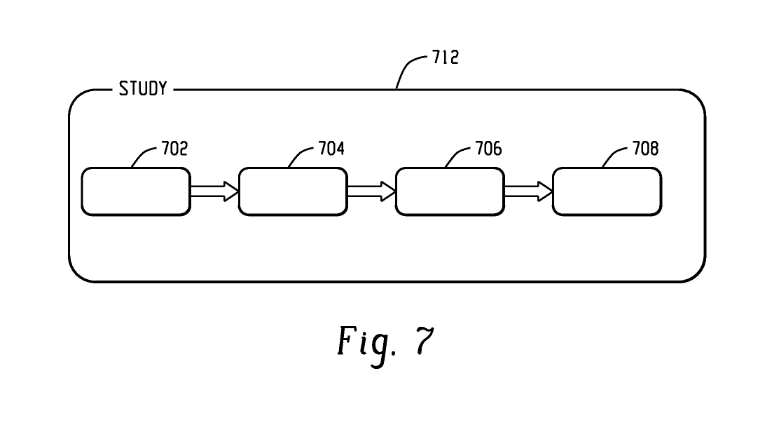

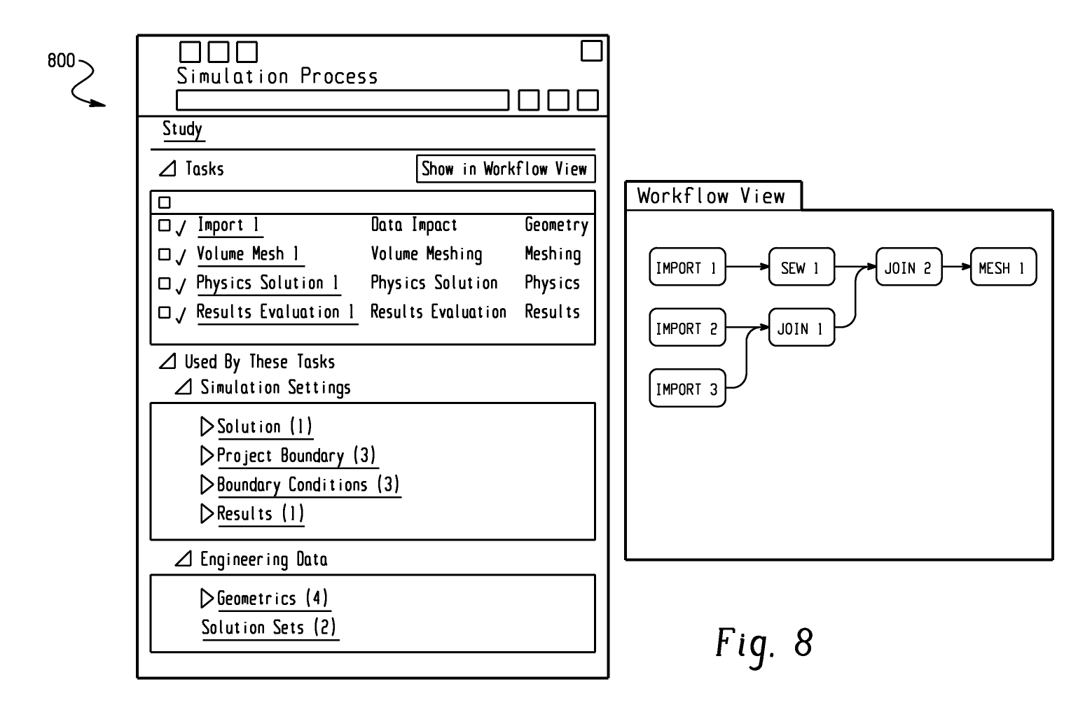

FIG. 7 depicts an example diagram showing a simulation process including multiple tasks. As shown in FIG. 7, four tasks 702, 704, 706 and 708 are connected in a sequential manner to define a single simulation process in a study object 712. FIG. 8 depicts an example diagram showing a simulation process on a user interface. As shown in FIG. 8, the simulation process 800 includes multiple tasks, simulation settings and engineering data used by the tasks.

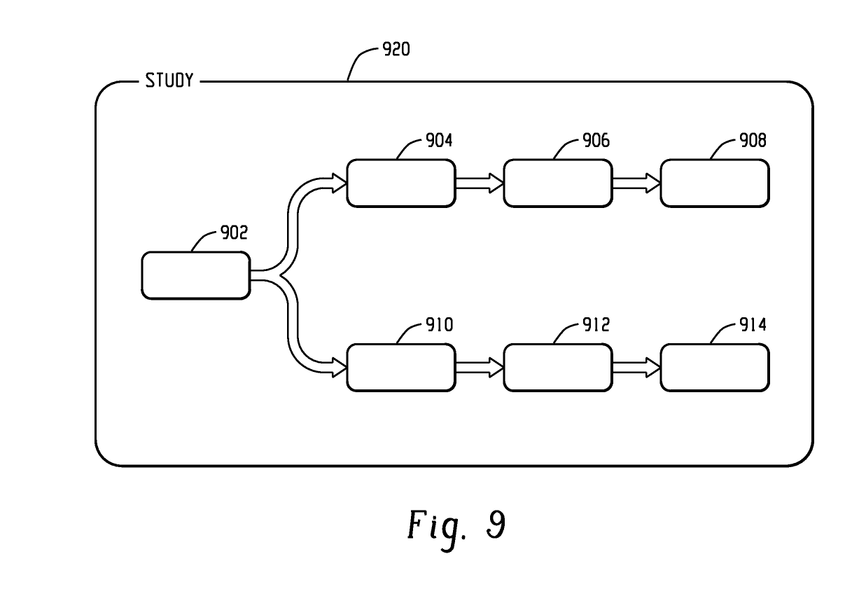

FIG. 9 depicts an example diagram showing multiple simulation processes including multiple tasks. As shown in FIG. 9, tasks 902, 904, 906, and 908 are connected in a sequential manner to define a simulation process, and the task 902 (e.g., a geometry import task) is also connected in a sequential manner with tasks 910, 912 and 914 to define another simulation process in a study object 920.

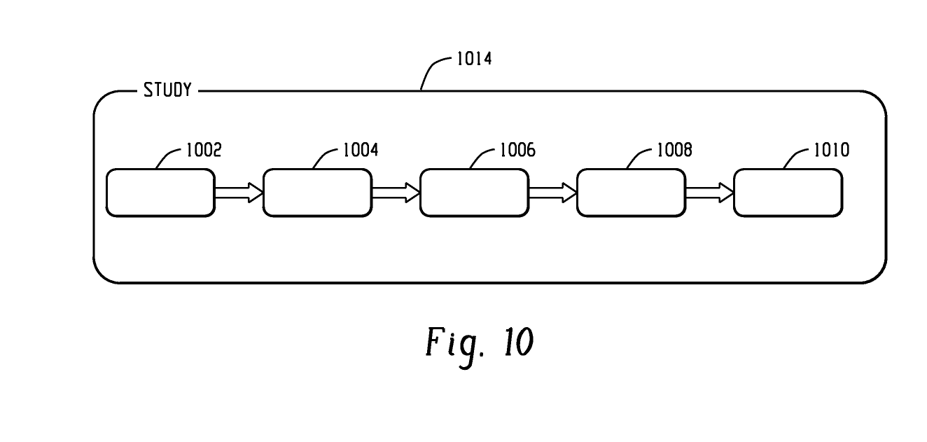

FIG. 10 depicts another example diagram showing a simulation process including multiple tasks. Five tasks 1002, 1004, 1006, 1008 and 1010 are connected in a sequential manner to define a single simulation process in a study object 1014. For example, the tasks 1002, 1004, 1006, 1008 and 1010 are set up for sequenced physics, e.g., Static Structural→Transient Structural, or Steady Flow→Transient Flow. Other applications are included for assembly meshing, where there are tasks to wrap and then fuse (or partition) geometry.

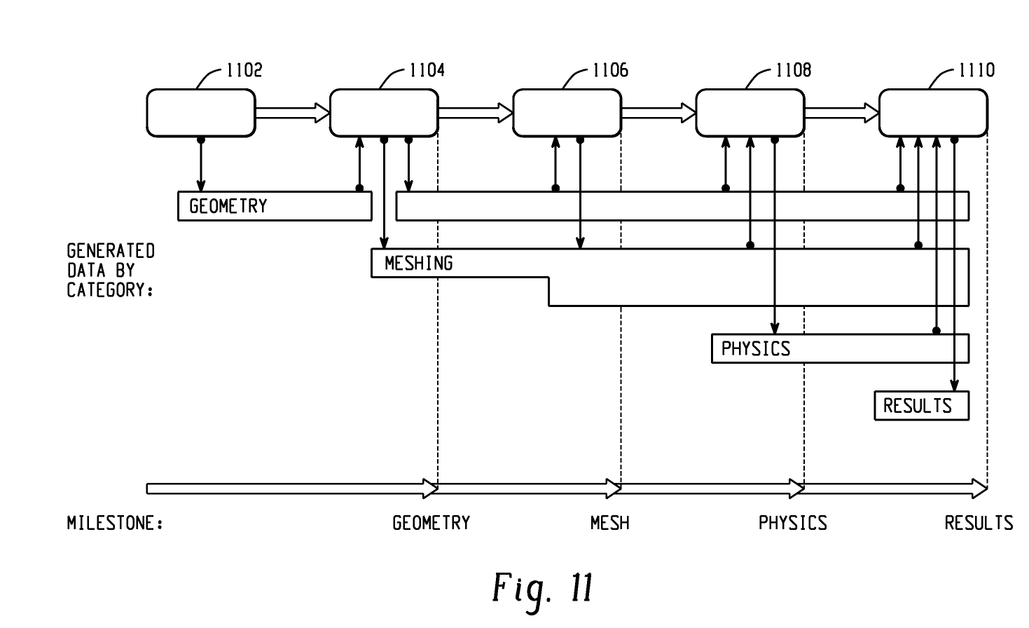

FIG. 11 depicts an example diagram showing various simulation milestones fulfilled by different tasks. Five tasks 1102, 1104, 1106, 1108 and 1110 are connected in a sequential manner to define a single simulation process. Specifically, the tasks 1102, 1104, 1106, 1108 and 1110 are associated with input data and output data of different categories. For example, the task 1102 outputs geometry data, and the task 1104 receives geometry data as input and outputs meshing data and geometry data. In addition, the tasks 1106 receives geometry data and outputs meshing data, and the task 1108 receives both geometry data and meshing data as input and outputs physics data. The task 1110 receives geometry data, meshing data and physics data, and outputs results data.

As shown in FIG. 11, the task 1104 is the last task that modifies the geometry data, and thus fulfills the simulation milestone related to geometry. The task 1106 is the last task that modifies the meshing data, and thus fulfills the milestone of mesh. In addition, the task 1108 and 1110 fulfill the milestones of physics and results respectively. As an example, if there is no selective meshing, interface fusion fulfills the milestone of mesh. In addition, the results data can be evaluated, and collected to generate a report for a user.

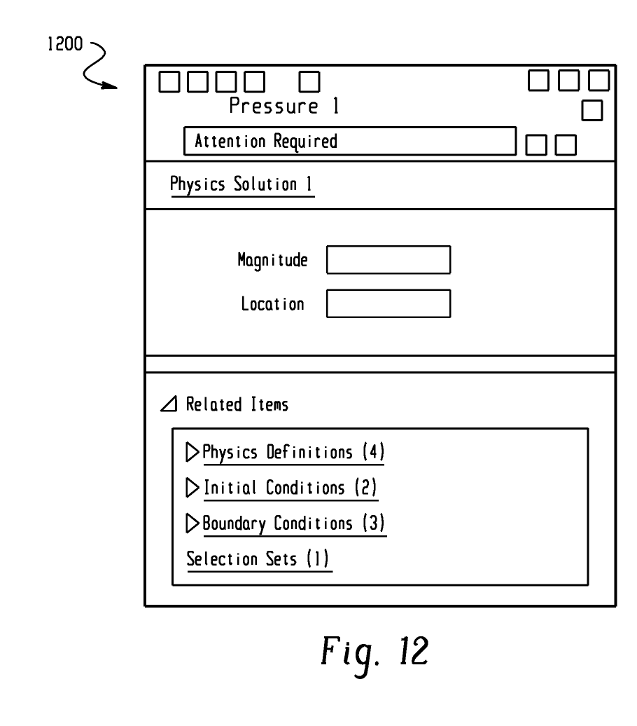

FIG. 12 depicts an example diagram showing a simulation settings object on a user interface. As shown in FIG. 12, the simulation settings object 1200 includes a physics solution object, and related items, such as physics definitions, initial conditions, boundary conditions, etc.

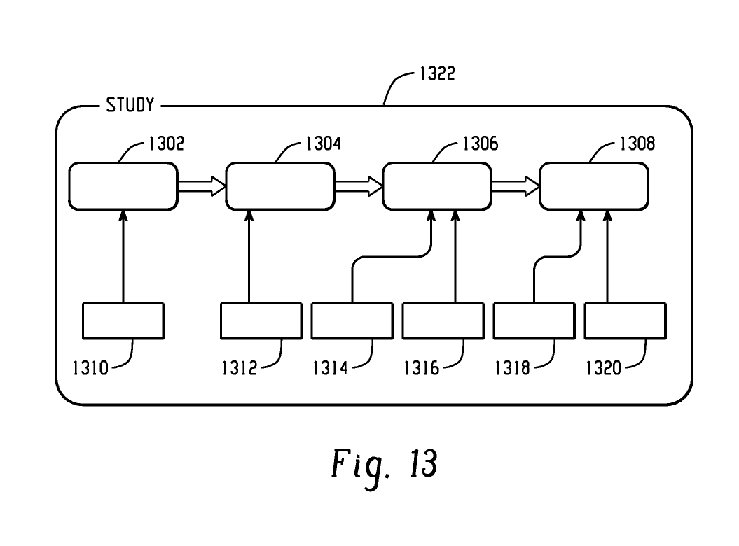

FIG. 13 depicts an example diagram showing a simulation process using simulation settings. Tasks 1302, 1304, 1306 and 1308 are connected in a sequential manner to define a single simulation process in a study object 1322. Input to the simulation process is defined by simulation settings objects 1310, 1312, 1314, 1316, 1318 and 1320.

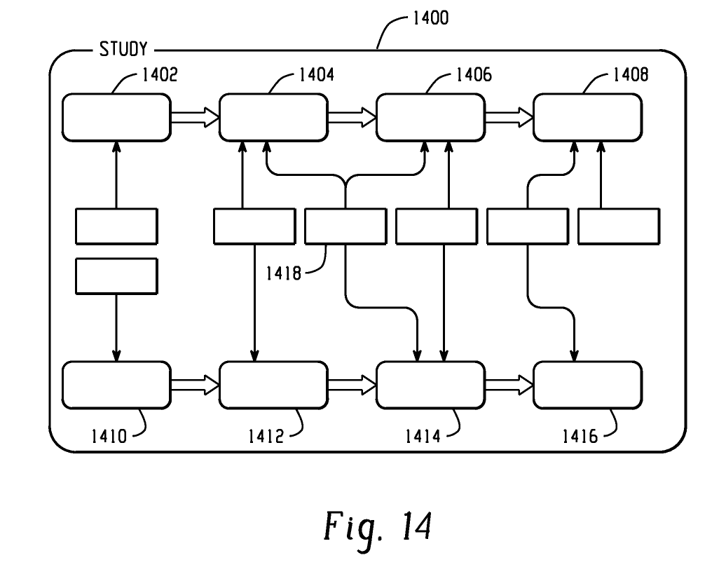

FIG. 14 depicts an example diagram showing simulation settings associated with multiple simulation processes. In a study object 1400, tasks 1402, 1404, 1406 and 1408 are connected in a sequential manner to define a simulation process, and tasks 1410, 1412, 1414 and 1416 are connected in a sequential manner to define another simulation process. Input to both simulation processes is defined by simulation settings objects (e.g., the simulation settings object 1418). The simulation settings objects provide simulation specific data and can be reused by multiple simulation processes, or by multiple tasks in the simulation processes. As shown in FIG. 14, the simulation settings object 1418 is reused by both simulation processes, and reused by both tasks 1404 and 1406 in a same simulation process.

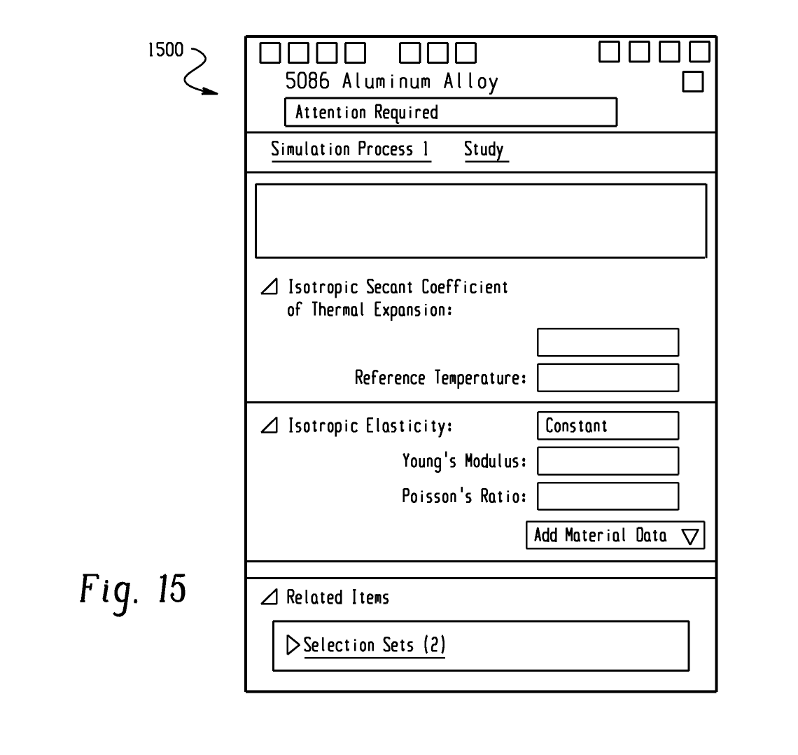

FIG. 15 depicts an example diagram showing an engineering data object on a user interface. As shown in FIG. 15, the engineering data object 1500 includes information related to a simulation process for which the engineering data object 1500 provides support.

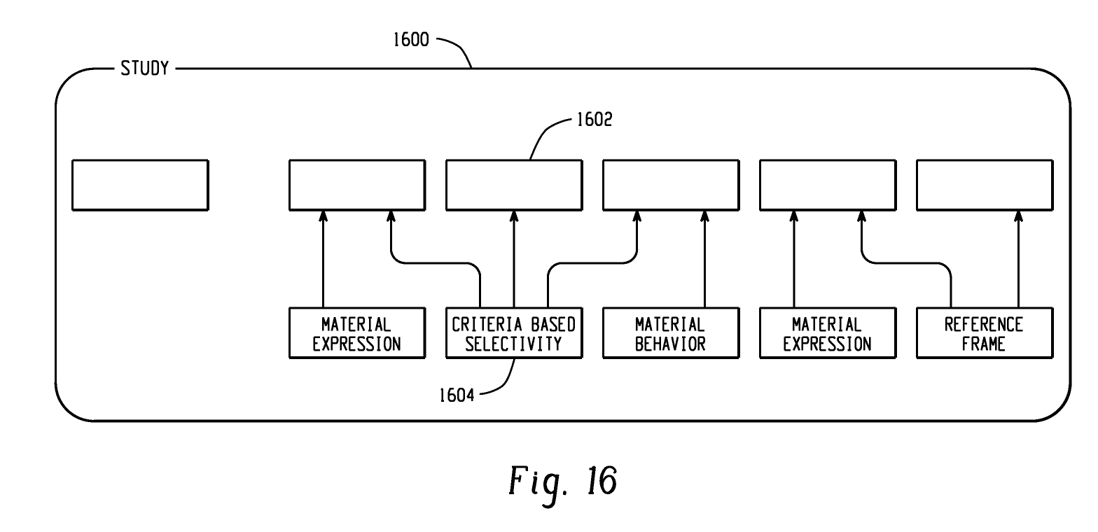

FIG. 16 depicts an example diagram showing simulation settings defined by engineering data. As shown in FIG. 16, one or more simulation settings objects (e.g., the simulation settings object 1602) are provided in a study object 1600, and one or more engineering data objects (e.g., the engineering data object 1604) are used to define the simulation settings objects.

The engineering data objects are reusable. For example, reference frames in the engineering data objects can be used between many simulation setting objects. The engineering data objects (e.g., material definitions, named expressions for defining load curves, etc.) can be stored external to the study object 1600, for example, in an engineering data library.

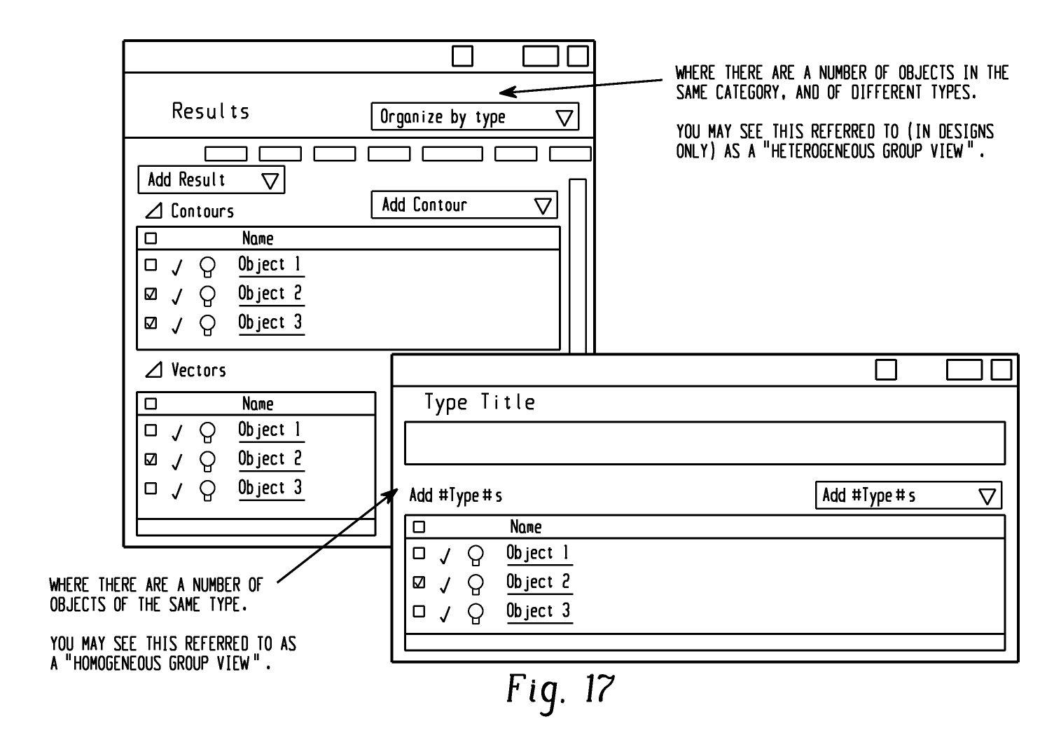

FIG. 17 depicts an example diagram showing a group view of objects on a user interface. As shown in FIG. 17, object based data can be shown in a details panel view using a pattern from one or more of the designs: study, task, simulation settings, and engineering data. Data for dynamic search can be shown in one or more of the designed views: simulation process, heterogeneous group, and homogeneous group. Designs can be made at a template level for tasks, simulation settings and engineering data where each can be designed separately.

Referring back to FIG. 1, the model operation system 104 can include object classification and a search-and-select tool. Different objects are assigned a type, such as “mesh control.” Different types can be grouped into categories. For example, the types “Point Load” and “Surface Load” can be categorized as “Boundary Conditions.” In addition, the search-and-select tool can provide the capability to identify a group or a single object based on the type and the category, plus the relationship to a single task, or a simulation process (e.g., a chain of tasks). The search-and-select tool can enable searching by further criteria beyond type and category, e.g., property values.

There are various methods of navigating to an object, or dynamic collection of objects. For example, the search-and-select tool is used to define one or more criteria. Further, “links” in a details panel can provide a convenient navigation, by setting search and select criteria. Links can be provided for: referenced items, e.g., simulation setting objects used with a task or engineering data objects used by a simulation setting's property. In addition, links can be provided for related items, e.g., those that are related by a modeling relationship such as a same physics region, etc. A mouse-based interaction, or a workflow-view-based navigation can also be used for navigating to an object. Various views (e.g., a details panel, graphics, a search-and-select tool) can be synchronized.

The model operation system 104 can also include state handling. For example, tasks, simulation settings and engineering data objects can have a state, e.g., up-to-date, out-of-date, attention required, etc., per the workflow document. A task can be out-of-date even if all the simulation settings and engineering data objects are up-to-date. This would indicate that the task is ready to be updated. Tasks may not be able to be updated if the simulation setting or data objects they reference require attention, and the task state is out-of-date. Upstream tasks of a given task should be up-to-date to enable the given task to be updated.

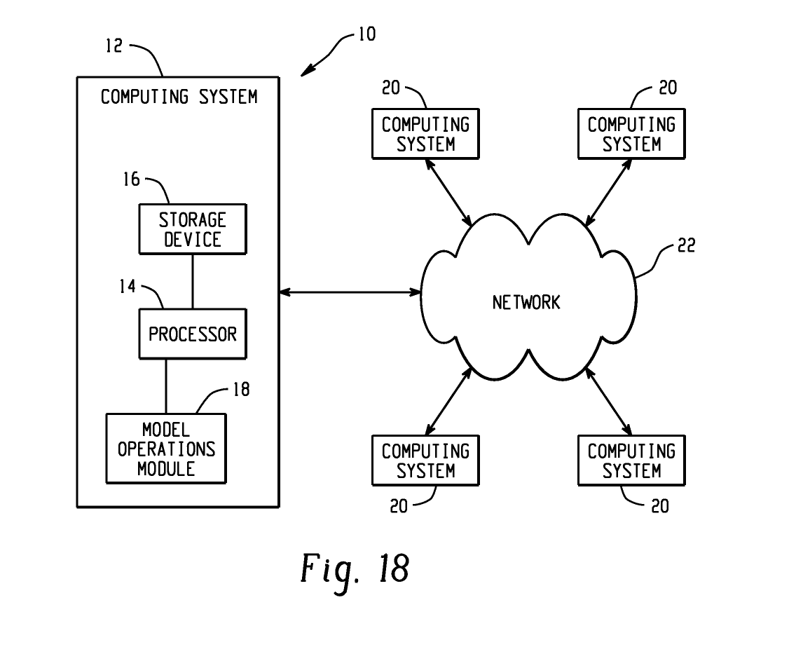

FIG. 18 depicts an example diagram showing a system for performing model operations to generate an engineering model. As shown in FIG. 18, the system 10 includes a computing system 12 which contains a processor 14, a storage device 16 and a model operations module 18. The computing system 12 includes any suitable type of computing device (e.g., a server, a desktop, a laptop, a tablet, a mobile phone, etc.) that includes the processor 14 or provide access to a processor via a network or as part of a cloud based application. The model operation module 18 includes tasks and is implemented as part of a user interface module (not shown in FIG. 18).

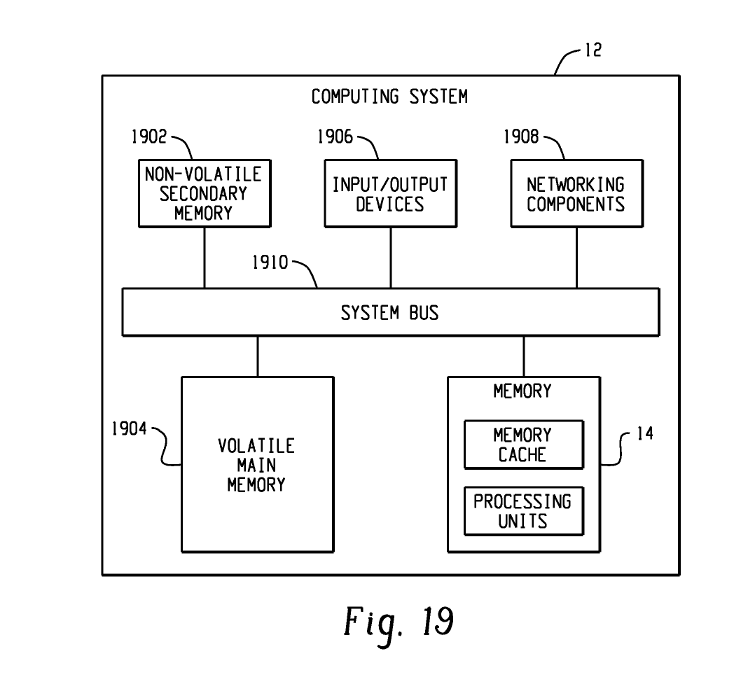

FIG. 19 depicts an example diagram showing a computing system for performing model operations to generate an engineering model. As shown in FIG. 19, the computing system 12 includes a processor 14, memory devices 1902 and 1904, one or more input/output devices 1906, one or more networking components 1908, and a system bus 1910. In some embodiments, the computing system 12 includes the model-operation module 18, and provides access to the model-operation module 18 to a user as a stand-alone computer.

This written description uses examples to disclose the invention, including the best mode, and also to enable a person skilled in the art to make and use the invention. The patentable scope of the invention may include other examples.

For example, the systems and methods may include data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of non-transitory computer-readable storage medium that is stored at a single location or distributed across multiple locations. The medium can include computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example, as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

It is claimed:

1. A processor-implemented system for creating an engineering model for analyzing a physical object, the system comprising:
a non-transitory computer-readable storage medium configured to store data related to a computer-assisted-design (CAD) model; and
one or more data processors configured to:
receive the CAD model including one or more original model elements;
perform one or more model operations based at least in part on the CAD model; and
generate, based at least in part on a mapping data structure, an engineering model including one or more target model elements, the mapping data structure associating the target model elements with the original model elements; and
store, in the non-transitory computer-readable storage medium, the mapping data structure and data related to the engineering model for analyzing a physical object.

2. The system of claim 1, wherein:
the CAD model includes a CAD topology;
the engineering model includes an engineering topology; and
the mapping data structure associates the CAD topology with the engineering topology.

3. The system of claim 2, wherein:
the CAD topology includes original vertices, original edges, original faces, original bodies or related original connections; and
the engineering topology includes target vertices, target edges, target faces, target bodies or related target connections.

4. The system of claim 1, wherein:
the CAD model includes one or more original geometric components;
the engineering model includes one or more target geometric components; and
the mapping data structure associates the original geometric components with the target geometric components.

5. The system of claim 1, wherein:
the CAD model includes an original mesh;
the engineering model includes a target mesh; and
the mapping data structure associates the original mesh with the target mesh.

6. The system of claim 1, wherein the one or more model operations include one or more of: meshing, geometry modeling, wrapping, partition, mesh connections, fracture, dimensional reduction, configuration management and combination, and import.

7. The system of claim 6, wherein the meshing includes generation of a mesh based on a CAD topology related to the CAD model.

8. The system of claim 6, wherein the geometry modeling includes modification of geometric components in the CAD model using a modeling kernel or virtual operations.

9. The system of claim 6, wherein the wrapping includes shrink-wrapping of components of a CAD topology related to the CAD model to create an engineering topology related to the engineering model.

10. The system of claim 6, wherein the partition includes extraction of a flow volume using a conformal solid topology based on the original model elements.

11. The system of claim 6, wherein the mesh connections include connection or welding of one or more shell models in the CAD model together at a mesh level.

12. The system of claim 6, wherein the fracture includes insertion of a crack into a mesh of the CAD model.

13. The system of claim 6, further comprising:
a user interface configured to provide a process representation for a user to select and change the one or more model operations.

14. The system of claim 1, wherein the engineering model is used for beam and shell analysis related to the physical object.

15. The system of claim 1, wherein the engineering model is used for welding analysis related to the physical object.

16. The system of claim 1, wherein the engineering model is used for reduced dimension modeling of the physical object.

17. The system of claim 1, wherein the engineering model is used for fracture mechanics analysis related to the physical object.

18. A processor-implemented method for creating an engineering model for analyzing a physical object, the method comprising:
receiving, by one or more data processors, a computer-assisted-design (CAD) model including one or more original model elements;
performing, by the one or more data processors, one or more model operations based at least in part on the CAD model;
generating, by the one or more data processors, an engineering model including one or more target model elements based at least in part on a mapping data structure, the mapping data structure associating the target model elements with the original model elements; and
storing, in a non-transitory computer-readable storage medium, data related to the CAD model, the mapping data structure and data related to the engineering model for analyzing a physical object.

19. The method of claim 18, wherein generating the engineering model includes:
generating an engineering topology based at least in part on the one or more model operations;
wherein the engineering topology is associated with a CAD topology related to the CAD model by the mapping data structure.

20. The method of claim 19, wherein generating the engineering model further includes:
applying condition data to the engineering topology; and
generating a volume mesh based on the engineering topology for a physics solution.

21. The method of claim 18, wherein the condition data includes one or more of: physics definitions, initial conditions and boundary conditions.

22. A processor-implemented system for creating an engineering model for analyzing a physical object, the system comprising:
a non-transitory computer-readable storage medium configured to store data related to a computer-assisted-design (CAD) model; and
one or more data processors configured to:
determine one or more simulation processes for the CAD model;
wherein the simulation processes include a first task being sequentially connected to multiple second tasks;
provide a visual representation of the one or more simulation processes on a user interface;
receive user operations on the first task and the second tasks from the user interface to modify the one or more simulation processes;
perform the one or more simulation processes to generate an engineering model based at least in part on a mapping data structure, the mapping data structure associating the engineering model with the CAD model; and
store, in the non-transitory computer-readable storage medium, the mapping data structure, data related to the simulation processes, and data related to the engineering model for analyzing a physical object.

23. The system of claim 22, wherein the data related to the simulation processes includes simulation settings that can be used among the first task and the second tasks.

24. The system of claim 22, wherein the data related to the simulation processes includes engineering data that can be used among the first task and the second tasks.

25. The system of claim 22, wherein the user operations include one or more of: adding a third task to the simulation processes, deleting the first task or the second tasks from the simulation processes, replacing the first task or the second tasks with one or more fourth tasks, and reordering the first task and the second tasks.

26. The system of claim 22, wherein the first task or the second tasks are configured to receive input data and generate output data.

27. The system of claim 26, wherein the input data and the output data include one or more of: geometry data, meshing data, physics data, and results data.

28. The system of claim 22, wherein the one or more data processors are further configured to: evaluate results data related to the simulation processes.

29. The system of claim 22, wherein the one or more data processors are further configured to:
collect data related to the first task or the second tasks; and
generate a user report based at least in part on the collected data related to the first task or the second tasks.

30. A processor-implemented method for creating an engineering model for analyzing a physical object, the method comprising:
determining, by one or more data processors, one or more simulation processes for a computer-assisted-design (CAD) model;
wherein the simulation processes include a first task being sequentially connected to multiple second tasks;
providing, by the one or more data processors, a visual representation of the one or more simulation processes on a user interface;
receiving user operations on the first task and the second tasks from the user interface to modify the one or more simulation processes;
performing, by the one or more data processors, the one or more simulation processes to generate an engineering model based on at least in part on a mapping data structure, the mapping data structure associating the engineering model with the CAD model;
storing, in a non-transitory computer-readable storage medium, data related to the CAD model, the mapping data structure, data related to the simulation processes, data related to the engineering model for analyzing a physical object.

31. A machine-readable non-transitory medium having stored data representing sets of instructions which, when executed by a machine, cause the machine to:
receiving, by one or more data processors, a computer-assisted-design (CAD) model including one or more original model elements;
performing, by the one or more data processors, one or more model operations based at least in part on the CAD model;
generating, by the one or more data processors, an engineering model including one or more target model elements based at least in part on a mapping data structure, the mapping data structure associating the target model elements with the original model elements; and
storing, in a non-transitory computer-readable storage medium, data related to the CAD model, the mapping data structure and data related to the engineering model for analyzing a physical object.

32. A machine-readable non-transitory medium having stored data representing sets of instructions which, when executed by a machine, cause the machine to:
determining, by one or more data processors, one or more simulation processes for a computer-assisted-design (CAD) model;
wherein the simulation processes include a first task being sequentially connected to multiple second tasks;
providing, by the one or more data processors, a visual representation of the one or more simulation processes on a user interface;
receiving user operations on the first task and the second tasks from the user interface to modify the one or more simulation processes;
performing, by the one or more data processors, the one or more simulation processes to generate an engineering model based on at least in part on a mapping data structure, the mapping data structure associating the engineering model with the CAD model;
storing, in a non-transitory computer-readable storage medium, data related to the CAD model, the mapping data structure, data related to the simulation processes, data related to the engineering model for analyzing a physical object.
